(19) United States
(12) Patent Application Publication
(10) Pub. No.: US 2026/0016978 A1
(43) Pub. Date: Jan. 15, 2026

(54) WRITE OPERATIONS USING MEMORY SUB-SYSTEM CONTROLLER MEMORY BUFFER DURING ARTIFICIAL INTELLIGENCE INFERENCE

(71) Applicant: Micron Technology, Inc., Boise, ID (US)

(72) Inventors: Luca Bert, Bologna (IT); Suresh Rajgopal, San Diego, CA (US)

(21) Appl. No.: 19/261,576

(22) Filed: Jul. 7, 2025

Related U.S. Application Data
(60) Provisional application No. 63/671,679, filed on Jul. 15, 2024.

(51) Int. Cl. G06F 3/06

(52) U.S. Cl. CPC G06F 3/064; G06F 3/0604; G06F 3/0656; G06F 3/0679

(57) ABSTRACT

A processing device in a memory sub-system stores a block of data from a non-volatile memory device of the memory sub-system in a controller memory buffer, the block of data comprising a plurality of chunks of data, wherein the memory sub-system comprises a volatile memory device with a first portion configured as the controller memory buffer. The processing device further provides a first chunk of data of the plurality of chunks of data from the controller memory buffer to a host system, receiving, from the host system, a write command and a modified chunk of data, the modified chunk of data comprising at least one modification to the first chunk of data, and writes the modified chunk of data to the block of data in the controller memory buffer.

### RELATED APPLICATIONS

This application is a continuation of U.S. Provisional Application No. 63/671,679, filed Jul. 15, 2024, the entire contents of which is hereby incorporated by reference herein.

### TECHNICAL FIELD

Embodiments of the disclosure relate generally to memory sub-systems, and more specifically, relate to write operations using a memory sub-system controller memory buffer during artificial intelligence inference.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory sub-system in accordance with some embodiments of the present disclosure.

FIG. 2 is a block diagram illustrating a system for performing read or write operations using a memory sub-system controller memory buffer during artificial intelligence inference in accordance with some embodiments of the present disclosure.

FIG. 3 is a flow diagram of an example method of performing read operations using a memory sub-system controller memory buffer during artificial intelligence inference in accordance with some embodiments of the present disclosure.

FIG. 4 is a block diagram illustrating data transfer operations associated with a memory sub-system controller memory buffer in accordance with some embodiments of the present disclosure.

FIG. 5 is a flow diagram of an example method of performing write operations using a memory sub-system controller memory buffer during artificial intelligence inference in accordance with some embodiments of the present disclosure.

FIG. 6 is a block diagram of an example computer system in which embodiments of the present disclosure may operate.

### DETAILED DESCRIPTION

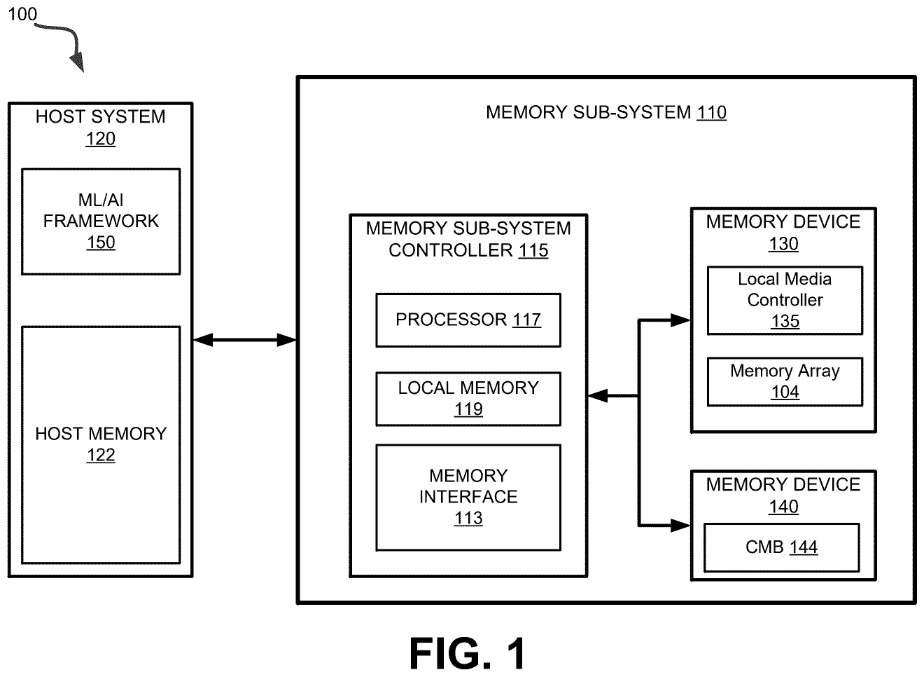

Aspects of the present disclosure are directed to write operations using a memory sub-system controller memory buffer during artificial intelligence inference. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. For example, NAND memory, such as 3D flash NAND memory, offers storage in the form of compact, high density configurations. A non-volatile memory device is a package of one or more dice, each including one or more planes. For some types of non-volatile memory devices (e.g., NAND memory), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can be made up of bits arranged in a two-dimensional or a three-dimensional grid. Memory cells are formed onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane.

One example of a memory sub-system is a solid-state drive (SSD) that includes one or more non-volatile memory devices and a memory sub-system controller to manage the non-volatile memory devices. In some implementations, memory sub-systems can be used to store data used to train machine learning (ML) and artificial intelligence (AI) frameworks, as well as data on which the ML/AI framework can be executed. Certain ML/AI frameworks include a model, which is a representation of a neural network designed to receive example data as input and classify the example data into a particular type or class. In such frameworks, the amount of data used to train the ML models can be extremely large and a training process cycle can be executed multiple times (e.g., multiple “epochs”). For example, an ML framework used to classify an image as being a particular type of image (e.g., an image of a person, an animal, a type of animal, etc.) can utilize a large data set of stored images that are repeatedly processed in multiple epoch cycles to train the model. Similarly, data sets used for testing and/or inference stages of a ML/AI workflow can include very large amounts of data. For, example the inference stage utilizes the trained model, which is very large and requires significant storage, to make predictions or decisions on new input data. This process can include processing the input data, feeding it into the model, and post-processing the output of the model if necessary.

In order to process the large amounts of data, many host systems executing ML/AI frameworks include multiple processing cores (e.g., graphics processing units (GPUs)) which can process multiple threads/streams in parallel. During the inference phase, these processing cores utilize relatively small chunks of data (e.g., tens or hundreds of bytes) from a significantly larger corpus of data (e.g., many gigabytes or terabytes) stored at a memory sub-system. Once example could include walking through a number of graph nodes in order to determine the value of a vertex element and its connections. In order to be efficient, the input data can be loaded from the memory sub-system to a local host memory co-located with the processing cores executing the ML/AI framework. This host memory is often implemented using high bandwidth memory (HBM) devices that offer extremely high (i.e., fast) performance, but have relatively low storage capacities. Accordingly, not all of the input data can be stored in the host memory due to size constraints, and is instead rotated in and out of the host memory (e.g., from/to the memory sub-system) as needed. The memory sub-system, however, can read and write data only at the block level (e.g., an entire logical block address (LBA) at a time). Depending on the implementation, this LBA size may be either 512 bytes or 4 kilobytes, for example, while the data chunks needed by the ML/AI framework are often much smaller, such as 64 bytes-128 bytes, for example. Thus, when a full LBA is copied from the memory sub-system to the host memory, a significant portion of the data is not needed and is unused. This hurts the efficiency of the host system and wastes the limited capacity of the host memory (i.e., increases undesirable memory amplification).

Aspects of the present disclosure address the above and other deficiencies by performing read operations using a memory sub-system controller memory buffer (CMB) during the inference phase for ML/AI applications. In one embodiment, the memory sub-system includes a non-volatile memory device (e.g., NAND-type flash memory) where the ML/AI input data is stored, as well as a volatile memory device (e.g., DRAM, SRAM) that can be used as a data buffer. In one embodiment, at least a portion of the volatile memory device is configured as a controller memory buffer (CMB), such that it can serve as a directly addressable memory space accessible to the host system executing an ML/AI framework. Thus, when the ML/AI framework sends a request to read data from the memory sub-system, the ML/AI framework can specify a destination address that is associated with the controller memory buffer. In response, processing logic of the memory sub-system can retrieve, from the non-volatile memory device, a block of data including the smaller chunk requested by the ML/AI framework, and store the block of data in the controller memory buffer region of the volatile memory device. Responsive to notifying the ML/AI framework on the host system that the requested data is available in the controller memory buffer, the ML/AI framework can initiate a data transfer operation (e.g., a direct memory access (DMA) operation) for the smaller chunk from the controller memory buffer. Thus, the requested chunk is returned to the host system, while the remainder of the block remains in the controller memory buffer, so that the ML/AI framework can use the chunk in whatever processing operations it is to perform, such as making an inference with respect to the input data. In addition, the ML/AI framework may modify the requested chunk during its operations, and the modified chunk can be replaced into the block in the controller memory buffer upon completion.

Advantages of the approach described herein include, but are not limited to, improved performance of the memory sub-system, particularly with respect to use with ML/AI frameworks. When using the controller memory buffer during an ML/AI inference phase, the entire block of data need not be transferred to and stored in the high bandwidth memory of the host system. Accordingly, the efficient utilization of this resource is significantly improved. In addition, use of the controller memory buffer is already supported by the existing NVM Express (NVMe) standard, so changes to the memory sub-system are not necessary for implementation. Only minor and non-intrusive updates are required to the host system protocols to make use of the controller memory buffer during read operations for the inference phase of ML/AI operations. The chunk of data that can be transferred to the host memory smaller than the smallest granularity supported by the memory sub-system and, to do so, specific code to move data can be added to the host system.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., one or more memory device(s) 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., the one or more memory device(s) 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device(s) 130) include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory device(s) 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 115 (or controller 115 for simplicity) can communicate with the memory device(s) 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device(s) 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 130. The memory sub-system controller 115 can further include host interface circuitry to communicate with the host system 120 via the physical host interface. The host interface circuitry can convert the commands received from the host system into command instructions to access the memory device(s) 130 as well as convert responses associated with the memory device(s) 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device(s) 130.

In some embodiments, the memory device(s) 130 include local media controllers 135 that operate in conjunction with memory sub-system controller 115 to execute operations on one or more memory cells of the memory device(s) 130. An external controller (e.g., memory sub-system controller 115) can externally manage the memory device 130 (e.g., perform media management operations on the memory device(s) 130). In some embodiments, a memory device 130 is a managed memory device, which is a raw memory device (e.g., memory array 104) having control logic (e.g., local controller 135) for media management within the same memory device package. An example of a managed memory device is a managed NAND (MNAND) device. Memory device(s) 130, for example, can each represent a single die having some control logic (e.g., local media controller 135) embodied thereon. In some embodiments, one or more components of memory sub-system 110 can be omitted.

In one embodiment, the host system 120 includes ML/AI framework 150. ML/AI framework 150 can include one or more ML models, a processing engine, and a training engine, among other components, which can be used to perform any automated task (e.g., classify or categorize documents or images). In order to train the one or more ML models, ML/AI framework 150 can issue requests to read the training data, which may be stored on memory device 130 of memory sub-system 110, and process the training data accordingly. In one embodiment, ML/AI framework 150 is executed by multiple processing cores (e.g., graphics processing units) which can process many threads/streams in parallel. For example, host system 120 could include hundreds of parallel processing threads that can request and process different subsets of the training data concurrently. Once a certain amount of training is complete, ML/AI framework 150 can enter an inference phase to analyze different input data. The input data can similarly be stored on memory device 130 of the same or a different memory sub-system 110. In one embodiment, ML/AI framework 150 can issue requests to read the input data from memory sub-system 110 and store a copy of the input data in a host memory 122. In one embodiment, the host system 120 utilizes a set of queues to track the memory access commands issued to the memory sub-system 110 (e.g., requests to read data for ML/AI framework 150). For example, the host system 120 can include a number of submission queues, storing submission queue entries representing the memory access commands issued to the memory sub-system 110, and a number of completion queues, storing completion queue entries received from the memory sub-system 110 to indicate that the corresponding memory access commands have been executed. In one embodiment, the host system 120 can maintain these queues in the host memory 122, which may be implemented as a dynamic random access memory (DRAM) device, a high bandwidth memory (HBM) device, or other memory device. High bandwidth memory can offer significantly faster data transfer rates compared to traditional memory technologies by placing memory chips vertically in a stacked configuration to allow for shorter data paths and faster communication between the memory chips and the processor.

In one embodiment, the memory sub-system 110 includes a memory interface 113 that is responsible for handling interactions of memory sub-system controller 115 with the memory devices of memory sub-system 110, such as memory device 130 and memory device 140. For example, the memory interface 113 can send memory access commands corresponding to requests received from host system 120 to memory device 130 and memory device 140, such as program commands, read commands, or other commands. In addition, the memory interface 113 can receive data from memory device 130 or memory device 140, such as data retrieved in response to a read command or a confirmation that a program command was successfully performed. In some embodiments, the memory sub-system controller 115 includes at least a portion of the memory interface 113. For example, the memory sub-system controller 115 can include a processor 117 (processing device) configured to execute instructions stored in local memory 119 for performing the operations described herein.

In one embodiment, at least a portion of volatile memory device 140 is configured as a controller memory buffer (CMB) 144. The controller memory buffer 144 can serve as a high-speed data buffer to cache frequently accessed data or instructions for a processing device (e.g., a GPU) of host system 120 executing ML/AI framework 150. In one embodiment, the controller memory buffer 144 provides a directly addressable memory space for host system 120, which can be used in place of or in addition to the limited sized host memory 122. For example, when ML/AI framework 150 sends a request to read data from the memory sub-system 110, the request may include a destination address that is associated with the controller memory buffer 144. In response, the memory interface 113 of memory sub-system controller 115 can retrieve, from the non-volatile memory device 130, a block of data including the smaller chunk requested by the ML/AI framework 150, and store the block of data in the controller memory buffer 144 of the volatile memory device 140. Responsive to notifying the ML/AI framework 150 on the host system 120 that the requested data is available in the controller memory buffer 144, the memory sub-system controller 115 can receive, from the ML/AI framework 150, a direct read request for the chunk in the controller memory buffer 144. The memory interface 113 can retrieve the requested chunk from the controller memory buffer 144 and return the chunk to the host system 120 (e.g., as part of the DMA operation), while the remainder of the block remains in the controller memory buffer 144, so that the ML/AI framework 150 can use the chunk as needed. Further details with regard to the use of the controller memory buffer 144 are described below.

In addition, the use of the controller memory buffer 144 provides an effective way to perform writes during the inference phase. There are certain characteristics of the inference phase that can be leveraged, although these may be not applicable for other write operations, such as those occurring outside the inference phase. For example, data is merely updated and never created during the inference phase. Any embedding that is used during the inference phase (e.g., new tokens, weights, etc.) will have been created during the prior training phase and may only be tuned (i.e., modified) during the inference phase in response to minor internal modifications. In addition, the embedding will have fixed size that does not grow or shrink. Thus, if the embedding read is 128 bytes, the modified one would be 128 bytes as well. While write operations require buffers to be allocated for a relatively long time, since the writes are relatively few and sparse during the inference phase, they can be accommodated by the buffer memory budget. Furthermore, there is only one inference node at any time that can work on any embedding. This avoids all issues due to collisions of multiple owners that may be more common for most parallel applications. Accordingly, the memory sub-system 110 can define an extension of the read path described herein that includes the update of any specific embedding, by performing a read-modify-write (RMW) type of operation. As described in more detail below, the data block read from memory device 130 can be maintained in controller memory buffer 144 until ML/AI framework 150 has completed operations using the requested chunk. In some embodiments, these operations can include a modification of the chunk, while stored in host memory 122. The modified chunk can be returned to controller memory buffer 144 and reinserted into the larger block. The block, including the modified chunk, can remain in the controller memory buffer 144 for some period of time, as it may represent an intermediate computation state during the inference phase, and may be read again by the ML/AI framework 150. In one embodiment, the entire larger block (including the modified chunk) can optionally be rewritten to memory device 130.

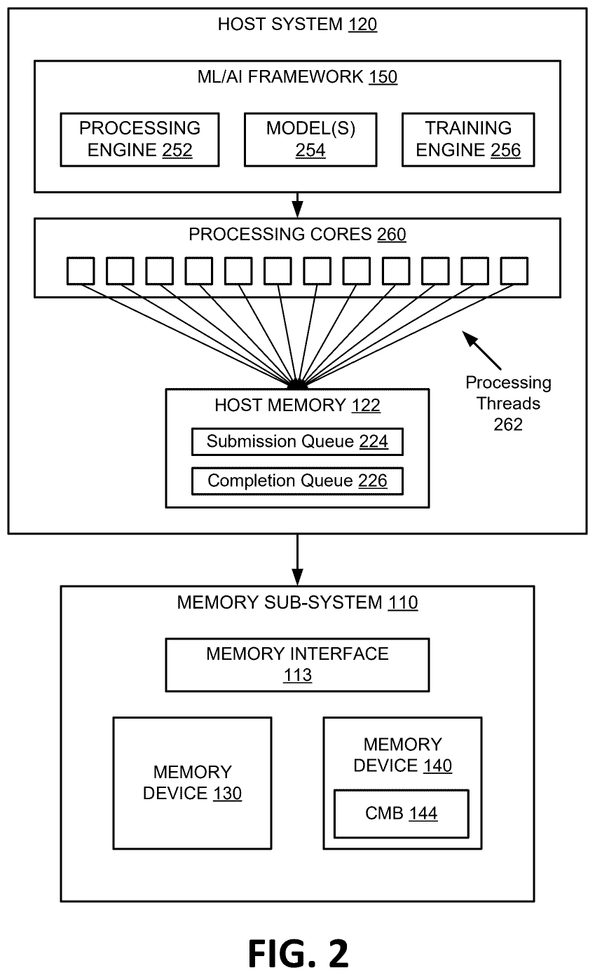

FIG. 2 is a block diagram illustrating a system for performing read or write operations using a memory sub-system controller memory buffer during artificial intelligence inference in accordance with some embodiments of the present disclosure. As illustrated, host system 120 includes ML/AI framework 150 which can be executed by a number of processing cores 260. Host system 120 further includes host memory 122, including submission queues 224 and completion queues 226. In one embodiment, ML/AI framework 150 includes a processing engine 252, one or more machine learning models 254, and a training engine 256, among other components, which can be used to perform any automated task (e.g., classify or categorize documents or images). Depending on the implementation one or more components that make up ML/AI framework 150 can be distributed across multiple different computing devices (e.g., host computers, servers, etc.). In one embodiment, processing engine 252 may use a set of trained machine learning models 254 that are trained and used to perform any number of automated operations. The processing engine 252 may also preprocess any received input data prior to using the data for training of the set of machine learning models 254 and/or applying the set of trained machine learning models 254 to the input data. Based on the output of the set of trained machine learning models 254, the processing engine 252 may obtain, for example, a classification and/or category of the input data, as well an assessment of the classification.

The set of machine learning models 254 may refer to model artifacts that are created by the training engine 256 using training data that includes training inputs and corresponding target outputs (i.e., correct answers for respective training inputs). During training, patterns in the training data that map the training input to the target output (i.e., the answer to be predicted) can be found, and are subsequently used by the machine learning models 254 for future predictions. Depending on the implementation, the set of machine learning models 254 may be composed of, for example, a single level of linear or non-linear operations (e.g., a support vector machine [SVM]) or may be a deep network, (i.e., a machine learning model that is composed of multiple levels of non-linear operations). Examples of deep networks are neural networks including convolutional neural networks, recurrent neural networks with one or more hidden layers, and fully connected neural networks.

Thus, in order to train and utilize the one or more machine learning models 254, ML/AI framework 150 can issue requests to read training data and input data, which may be stored on memory device 130 of memory sub-system 110, and process the data accordingly. In one embodiment, these memory access requests are sent by the parallel processing threads 262 being executed by processing cores 260. Processing cores 260 can include a number of general-purpose processing devices such as microprocessors, central processing units (CPUs), or the like, or more specialized processing devices, such as graphics processing units (GPUs), which may be optimized for performing high-speed sequential processing operations. Depending on the implementation there can be any number of processing cores 260 (e.g., tens or hundreds), each executing a respective one of processing threads 262. Each processing thread 262 represents a series of sequential operations directed to memory sub-system 110 (e.g., read requests for separate segments of an element of training or input data stored at memory sub-system 110). Due to the large relative size of the training data or input data, each element may be broken up into separate segments of a smaller fixed size and stored at sequential memory addresses in memory sub-system 110. Thus, in order to read the entire element of data, a sequence of multiple read requests can be issued to obtain all of the separate segments. Each processing thread 262 can include a series of read requests to read the segments of a different element of data from memory sub-system 110. Upon the read requests from each processing thread 262 being generated, the requests can be stored as entries in one of submission queues 224, from which they can be issued to memory sub-system 110. Received responses to the requests from memory sub-system 110 can be stored as entries in one of completion queues 226, retrieved by processing threads 262 and provided to ML/AI framework 150 for execution in either a training phase or an inference phase.

Memory interface 113 of memory sub-system 110 can receive the memory access requests from submission queues 224 and retrieve the requested data. For example, the requested data be a relatively small chunk (e.g., 64 bytes-128 bytes) that can be used as part of an inference being made by ML/AI framework 150. In one embodiment, the memory interface 113 can retrieve a larger block of data (e.g., 512 bytes or 4 kilobytes) which includes the smaller chunk requested by the ML/AI framework 150 from the non-volatile memory device 130 and store the entire block of data in the controller memory buffer 144 of the volatile memory device 140. Responsive to notifying the ML/AI framework 150 on the host system 120 that the requested data is available in the controller memory buffer 144, the memory sub-system controller 115 can receive, from the ML/AI framework 150, a direct read request for the chunk from the controller memory buffer 144. The memory interface 113 can retrieve the requested chunk from the controller memory buffer 144 and return the chunk to the host system 120, while the remainder of the block remains in the controller memory buffer 144. In one embodiment, the requested chunk can be transferred from the controller memory buffer 144 to the host memory 122, where it can be accessed by ML/AI framework 150 and used as needed.

In a system that does not include a controller memory buffer 144, the larger block of data can be retrieved from memory device 130, as described above, and stored in the volatile memory device 140. Since access to the volatile memory device 140, when not configured with a controller memory buffer, is limited to block-level access, the entire block (e.g., 4 kilobytes) is read by the host system 120 and copied to the host memory 122. The memory interface used for communication between host system 120 and memory sub-system 110 (e.g., NVMe) does not permit reading less than an entire logical block address from the memory sub-system 110, unless a portion of the memory is configured as a controller memory buffer. Once the data is stored in host memory 122, the ML/AI framework can access the smaller chunk needed for its inference or other operations. Thus, without a controller memory buffer, a double buffer approach is needed where the larger data block is first moved from non-volatile memory device 130 to volatile memory device 140 within the memory sub-system, and then moved again to the host memory 122 in host system 122 before it can be accessed by ML/AI framework 150. The controller memory buffer 144 eliminates the need for double buffering, as any amount of data can be read directly from the controller memory buffer 144, thereby permitting the ML/AI framework 150 to read the required small chunk directly from the controller memory buffer 144 in the memory sub-system 110.

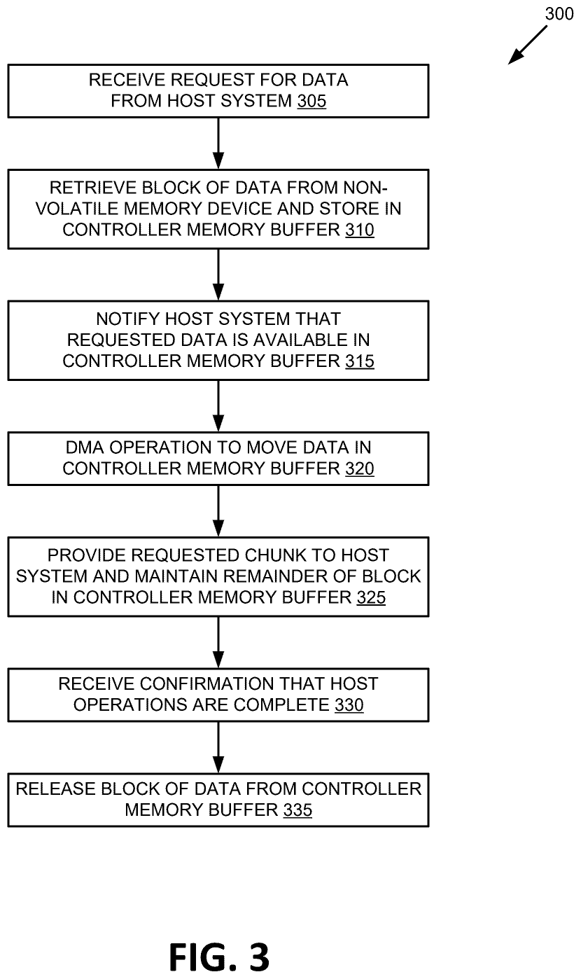

FIG. 3 is a flow diagram of an example method of performing read operations using a memory sub-system controller memory buffer during artificial intelligence inference in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the memory interface 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

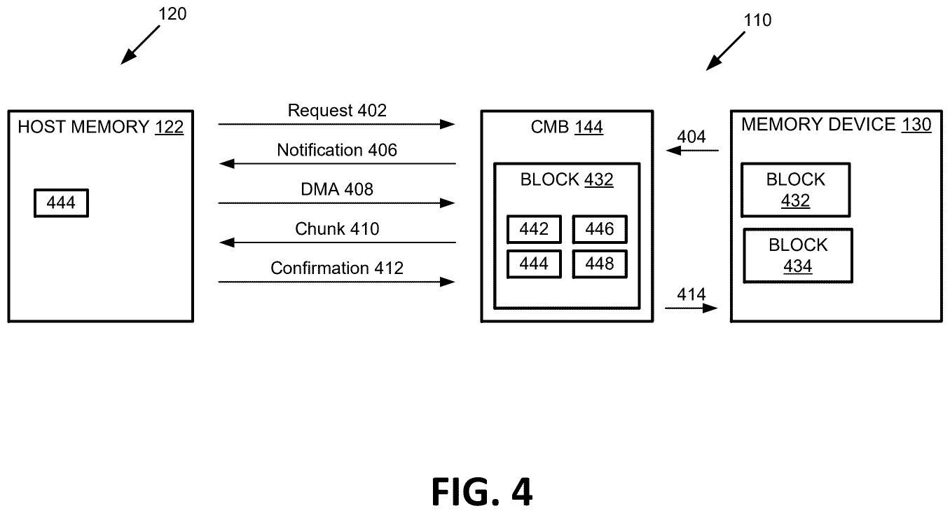

At operation 305, the processing logic (e.g., memory interface 113) receives, from a host system, such as host system 120, a memory access request for a chunk of data stored at a non-volatile memory device, such as memory device 130 of memory sub-system 110. In one embodiment, the memory access request includes a request to read input data from the non-volatile memory device 130 for an inference operation performed by at least one of a machine learning (ML) model or an artificial intelligence (AI) framework (e.g., ML/AL framework 150, machine learning model 254). For example, the request may be associated with one or more of a plurality of processing threads 262 executed by a plurality of processing cores 260 on the host system 120. In one embodiment, as illustrated in FIG. 4, the request 402 is received at memory sub-system 110 from host system 120 and may include a request for a specific chunk of data, such as chunk 444.

At operation 310, the processing logic retrieves a block of data comprising the chunk from the non-volatile memory device 130 and stores the block of data in a controller memory buffer 144 of the memory sub-system 110. For example, the memory sub-system 110 can include a volatile memory device 140, at least a portion of which is configured as a controller memory buffer (CMB) 144. The controller memory buffer 144 can serve as a high-speed data buffer to cache frequently accessed data or instructions for a processing device (e.g., a GPU) of host system 120 executing ML/AI framework 150. In one embodiment, the requested chunk of data is part of a larger block (i.e., the block of data is larger in size than the chunk, and the chunk represents a portion of the block of data). For example, the block (e.g., representing an entire LBA) may be approximately 512 bytes-4 kilobytes, while the data chunk is often much smaller, such as 64 bytes-128 bytes. In one embodiment, as illustrated in FIG. 4, non-volatile memory device 130 includes a number of blocks of data, such as blocks 432 and 434, each of which include a number of smaller chunks. At 404, for example, the block 432 containing the requested chunk 444 can be retrieved from non-volatile memory device 130 and stored in controller memory buffer 144. Block 432 may include any number of additional chunks, such as 442-448.

At operation 315, the processing logic sends a notification to the host system 120 that the chunk of data is available in the controller memory buffer 144. For example, when ML/AI framework 150 sends the request to read data from the memory sub-system 110 at operation 305, the request may include a destination address that is associated with the controller memory buffer 144. In response, the memory interface 113 of memory sub-system controller 115 can retrieve, from the non-volatile memory device 130, a block of data including the smaller chunk requested by the ML/AI framework 150, and store the block of data in the controller memory buffer 144 of the volatile memory device 140 at operation 310. Once the block is stored in the controller memory buffer 144, the processing logic can send a notification, such as notification 406 illustrated in FIG. 4, to the host system 120 to indicate that the requested chunk 444 is available in the controller memory buffer 144.

At operation 320, a direct memory access (DMA) operation is initiated by the host system 120 to move the chunk of data from the controller memory buffer 144. Responsive to notifying the ML/AI framework 150 on the host system 120 that the requested data is available in the controller memory buffer 144, the memory sub-system controller 115 can receive, from the ML/AI framework 150, a DMA request for the chunk in the controller memory buffer 144. In one embodiment, as illustrated in FIG. 4, the DMA 408 is received at memory sub-system 110 from host system 120. DMA is a system feature that allows the host system to directly transfer data between a memory device (e.g., the controller memory buffer 144) and the host memory 122 (e.g., HBM) without involving the central processing unit (CPU) of the host system 120. For example, a DMA controller (DMAC), or GPU of the host system 120, can manage these transfers by configuring source and destination addresses, transfer length, and direction. Once the ML/AI framework 150 requests a transfer, the DMAC arbitrates control of the system bus, performs the data transfer, and notifies the CPU upon completion. This mechanism offloads data transfer tasks from the CPU, allowing it to execute other processes concurrently, thereby improving overall system efficiency and performance. DMA is particularly advantageous in applications requiring high-speed data transfer and low CPU overhead, such as multimedia processing, networking, data acquisition, and storage systems.

At operation 325, the processing logic provides the chunk of data from the controller memory buffer 144 to the host system 120. Since the controller memory buffer 144 provides a directly addressable memory space for host system 120, which can be used in place of or in addition to the limited sized host memory 122, only the requested chunk of data can be read from the controller memory buffer 144 while the remainder of the block of data can be maintained in the controller memory buffer 144 after providing the chunk of data to the host system 120. In one embodiment, as illustrated in FIG. 4, the requested chunk 444 is provided to host system 120 at 410, and the chunk 444 can be stored directly to the host memory 122. The remainder of block 432, including chunks 442, 446, and 448 is maintained in the controller memory buffer 144.

At operation 330, the processing logic receives, from the host system, confirmation that host operations associated with the chunk of data are complete. For example, the ML/AI framework 150 can use the chunk in whatever processing operations it is to perform, such as making an inference with respect to the input data. Upon completion of those operations, ML/AI framework 150 can send a notification to the memory sub-system 110 to confirm that the operations are complete. This confirmation, such as confirmation 412 of FIG. 4, can be received by the processing logic of the memory sub-system 110.

At operation 335, the processing logic releases the block of data from the controller memory buffer 144. In one embodiment, responsive to receiving the confirmation that the host operations are complete, memory interface 113 can cause the block of data 432 from which the requested chunk 444 was read to be released, such as at 414 of FIG. 4, from the controller memory buffer 144. This frees additional space from the controller memory buffer 144 so that other input data can be stored therein. A copy of the block of data 432 remains in the non-volatile memory device 130 and can be retrieved again in the future according to operations 305-325.

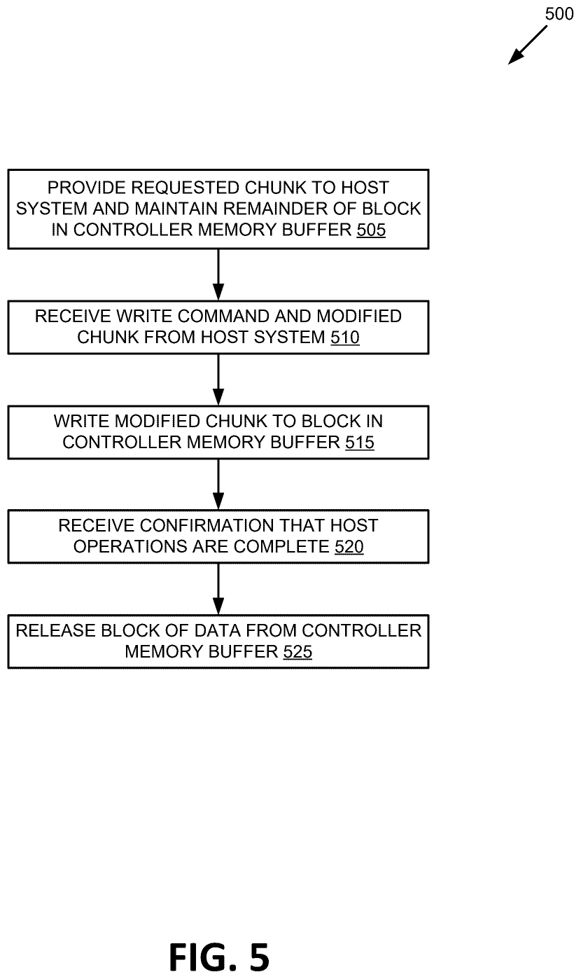

FIG. 5 is a flow diagram of an example method of performing write operations using a memory sub-system controller memory buffer during artificial intelligence inference in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the memory interface 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 505, the processing logic (e.g., memory interface 113) provides a requested chunk of data from the controller memory buffer 144 to the host system 120. Since the controller memory buffer 144 provides a directly addressable memory space for host system 120, which can be used in place of or in addition to the limited sized host memory 122, only the requested chunk of data can be read from the controller memory buffer 144 while the remainder of a block of data comprising the chunk can be maintained in the controller memory buffer 144 after providing the chunk of data to the host system 120. In one embodiment, as illustrated in FIG. 4, the requested chunk 444 is provided to host system 120 at 410 (e.g., in response to the DMA operation at 408), and the chunk 444 can be stored directly to the host memory 122. The remainder of block 432, including chunks 442, 446, and 448 is maintained in the controller memory buffer 144.

At operation 510, the processing logic receives a write command and a modified chunk from the host system 120. For example, the ML/AI framework 150 can use the chunk in whatever processing operations it is to perform, such as making an inference with respect to the input data. As part of these operations, the ML/AI framework 150 may modify (i.e., make one or more changes to) at least a portion of the chunk 444. For example, while the chunk 444 is stored in host memory 122, ML/AI framework 150 can read the chunk 444 and modify the chunk 444 (e.g., by adding data to the chunk, removing data from the chunk, or changing data in the chunk). Once modified, the ML/AI framework 150 can issue a write command, using existing communication protocols (e.g., NVMe), to the memory sub-system 110. In one embodiment, the modified chunk 444 maintains the same logical block address (LBA) value as the original chunk 444 read from the memory sub-system 110 and the write command includes a pointer to the controller memory buffer 144 indicating the location from which the original chunk 444 was read from the controller memory buffer 144 (e.g., at operation 325).

At operation 515, the processing logic writes the modified chunk 444 to the block 432 in the controller memory buffer 144. As indicated above, the remainder of block 432 is maintained in the controller memory buffer 144 while host system operations are performed. Thus, memory interface 113 can write the modified chunk 444 back to the same location (i.e., memory address) of block 432 while stored in the controller memory buffer 144. As the modified chunk 444 remains the same size as the original chunk, block 432 (even including the modified chunk 444) represents the entire logical block address size. The block 432, including the modified chunk 444, can remain in the controller memory buffer 144 for some period of time, as it may represent an intermediate computation state during the inference phase, and may be read again from the controller memory buffer 144 by the ML/AI framework 150.

At operation 520, the processing logic receives, from the host system, confirmation that host operations associated with the chunk of data are complete (i.e., there will be no further modifications to the data). Upon completion of those operations, ML/AI framework 150 can send a notification to the memory sub-system 110 to confirm that the operations are complete. This confirmation, such as confirmation 412 of FIG. 4, can be received by the processing logic of the memory sub-system 110.

At operation 525, the processing logic releases the block of data from the controller memory buffer 144. In one embodiment, responsive to receiving the confirmation that the host operations are complete, memory interface 113 can cause the block of data 432, including the modified chunk 444, to be released, such as at 414 of FIG. 4, from the controller memory buffer 144. This frees additional space from the controller memory buffer 144 so that other input data can be stored therein. A copy of the block of data 432 may optionally be stored in the non-volatile memory device 130 and can be retrieved again in the future according to operations 305-325.

Maintaining the blocks in the controller memory buffer 144 in case of modifications and write operations being performed will have an impact on the required size of the controller memory buffer 144. For example, the only support read operations for 16 gigabytes of data at a latency of 200 microseconds, the approximate size of the controller memory buffer 144 is 3.2 megabytes. To account for the data being maintained in the controller memory buffer 144 for a longer period of time, an increased size will be needed. Since write operations are relatively rare during the ML/AI inference stage, if one percent of operations utilize the read-modify-write functionality at an increase latency of 5 milliseconds, the additional capacity required for the controller memory buffer 144 would be 0.8 megabytes. Thus, a total size of the controller memory buffer 144 may be approximately 4 megabytes, in one implementation, which is within reasonable limits for memory sub-system 110.

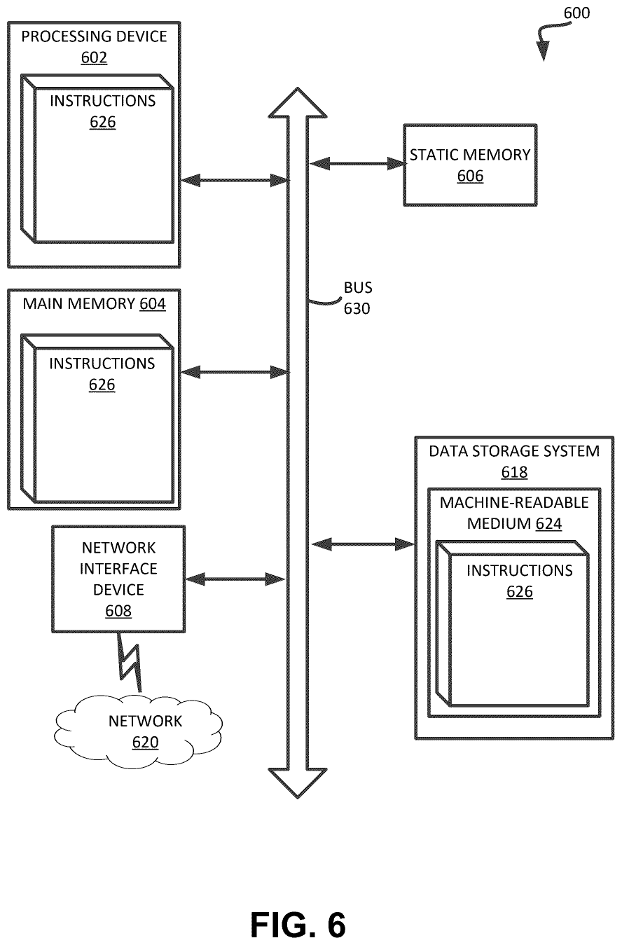

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the memory interface 113 or memory sub-system controller 115 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In one embodiment, the instructions 626 include instructions to implement functionality corresponding to the memory interface 113 of FIG. 1). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a non-volatile memory device;
a volatile memory device comprising a first portion configured as a controller memory buffer; and
a processing device, operatively coupled with the non-volatile memory device and the volatile memory device, to perform operations comprising:
storing a block of data from the non-volatile memory device in the controller memory buffer, the block of data comprising a plurality of chunks of data;
providing a first chunk of data of the plurality of chunks of data from the controller memory buffer to a host system;
receiving, from the host system, a write command and a modified chunk of data, the modified chunk of data comprising at least one modification to the first chunk of data; and
writing the modified chunk of data to the block of data in the controller memory buffer.

2. The system of claim 1, wherein the first chunk of data is modified to form the modified chunk of data during an inference operation performed by at least one of a machine learning (ML) model or an artificial intelligence (AI) framework.

3. The system of claim 1, wherein the block of data is larger in size than the first chunk of data, and wherein the first chunk of data represents a portion of the block of data.

4. The system of claim 1, wherein the controller memory buffer is accessible by the host system over an NVM Express (NVMe) interface and supports direct memory access (DMA) data transfers.

5. The system of claim 1, wherein the processing device is to perform operations further comprising:
sending a notification to the host system that the first chunk of data is available in the controller memory buffer; and
receiving a request from the host system to read the first chunk of data from the controller memory buffer.

6. The system of claim 1, wherein the processing device is to perform operations further comprising:
maintaining the block of data in the controller memory buffer after providing the first chunk of data to the host system.

7. The system of claim 6, wherein the processing device is to perform operations further comprising:
receiving, from the host system, confirmation that host operations associated with the first chunk of data are complete; and
releasing the block of data comprising the modified chunk of data from the controller memory buffer.

8. A method comprising:
storing a block of data from a non-volatile memory device of a memory sub-system in a controller memory buffer, the block of data comprising a plurality of chunks of data, wherein the memory sub-system comprises a volatile memory device with a first portion configured as the controller memory buffer;
providing a first chunk of data of the plurality of chunks of data from the controller memory buffer to a host system;
receiving, from the host system, a write command and a modified chunk of data, the modified chunk of data comprising at least one modification to the first chunk of data; and
writing the modified chunk of data to the block of data in the controller memory buffer.

9. The method of claim 8, wherein the first chunk of data is modified to form the modified chunk of data during an inference operation performed by at least one of a machine learning (ML) model or an artificial intelligence (AI) framework.

10. The method of claim 8, wherein the block of data is larger in size than the first chunk of data, and wherein the first chunk of data represents a portion of the block of data.

11. The method of claim 8, wherein the controller memory buffer is accessible by the host system over an NVM Express (NVMe) interface and supports direct memory access (DMA) data transfers.

12. The method of claim 8, further comprising:
sending a notification to the host system that the first chunk of data is available in the controller memory buffer; and
receiving a request from the host system to read the first chunk of data from the controller memory buffer.

13. The method of claim 8, further comprising:
maintaining the block of data in the controller memory buffer after providing the first chunk of data to the host system.

14. The method of claim 13, further comprising:
receiving, from the host system, confirmation that host operations associated with the first chunk of data are complete; and
releasing the block of data comprising the modified chunk of data from the controller memory buffer.

15. A non-transitory computer-readable storage medium comprising instructions that, when executed by a processing device, cause the processing device to perform operations comprising:
storing a block of data from a non-volatile memory device of a memory sub-system in a controller memory buffer, the block of data comprising a plurality of chunks of data, wherein the memory sub-system comprises a volatile memory device with a first portion configured as the controller memory buffer;
providing a first chunk of data of the plurality of chunks of data from the controller memory buffer to a host system;
receiving, from the host system, a write command and a modified chunk of data, the modified chunk of data comprising at least one modification to the first chunk of data; and
writing the modified chunk of data to the block of data in the controller memory buffer.

16. The non-transitory computer-readable storage medium of claim 15, wherein the first chunk of data is modified to form the modified chunk of data during an inference operation performed by at least one of a machine learning (ML) model or an artificial intelligence (AI) framework.

17. The non-transitory computer-readable storage medium of claim 15, wherein the block of data is larger in size than the first chunk of data, and wherein the first chunk of data represents a portion of the block of data.

18. The non-transitory computer-readable storage medium of claim 15, wherein the controller memory buffer is accessible by the host system over an NVM Express (NVMe) interface and supports direct memory access (DMA) data transfers.

19. The non-transitory computer-readable storage medium of claim 15, wherein the instructions cause the processing device to perform operations further comprising:
sending a notification to the host system that the first chunk of data is available in the controller memory buffer; and
receiving a request from the host system to read the first chunk of data from the controller memory buffer.

20. The non-transitory computer-readable storage medium of claim 15, wherein the instructions cause the processing device to perform operations further comprising:
maintaining the block of data in the controller memory buffer after providing the first chunk of data to the host system;
receiving, from the host system, confirmation that host operations associated with the first chunk of data are complete; and
releasing the block of data comprising the modified chunk of data from the controller memory buffer.
